(19) United States
(12) Patent Application Publication
(10) Pub. No.: US 2009/0032546 A1
(43) Pub. Date: Feb. 5, 2009

(54) PILL BOTTLE INCLUDING AN INTERNAL SLEEVE AND AN EXTERNAL SLEEVE

(76) Inventors: Theresa Litherland, Elkton, MD (US); Lizabeth London, Wynnewood, PA (US); Lawrence Kiey, Downington, PA (US); Debbie C. Heilman, Kennett Square, PA (US); David Trapani, West Chester, PA (US); Shaun Walsh, West Chester, PA (US); Juliet McQuillan, Wilmington, DE (US); Michael Forehand, Avondale, PA (US); Eric Christopher, Kennett Square, PA (US); Janice Jackson, Chaddsford, PA (US); Kathy Monday, Glen Mills, PA (US); Adele Gulfo, New York, NY (US); Tammi Gaskins, Wilmington, DE (US); Dipak Patel, New York, NY (US); Ryan Lynch, New York, NY (US); Jacqueline McSwiney, New York, NY (US); Ann M. Sullivan, Waltham, MA (US)

Correspondence Address: Weiss & Arons, LLP, 1540 Route 202, Suite 8, Pomona, NY, 10970, US

(21) Appl. No.: 11/832,131

(22) Filed: Aug. 1, 2007

(51) Int. Cl. G07F 9/02; G07F 11/00; B65D 83/04

(52) U.S. Cl. 221/2; 221/303; 206/540; 206/534

(57) ABSTRACT

Systems and methods for providing a pill bottle including an internal and external sleeve are provided. A pill bottle according to the invention may include an external sleeve and an internal sleeve. The internal sleeve preferably includes a cavity for holding pills. The external sleeve is slidably coupled to the internal sleeve. The external sleeve may include a groove and the internal sleeve may include a projection that may slide within the groove. The groove may prevent substantial rotation of the external sleeve with respect to the internal sleeve by preventing a substantial rotational of the projection with respect to the groove.

### BACKGROUND OF THE INVENTION

This patent application relates to pills and pill bottles. More specifically, this application relates to a pill bottle that may incorporate multiple ease-of-use and informational features.

Many pill bottles do not maintain human-friendly elements and, thereby, may serve to discourage patients from following appropriate medication regimens. Furthermore, such pill bottles have a sterile appearance which also tends to deter proper patient adherence to a prescribed course of medicine.

While certain pill bottles incorporate features that enhance ease-of-use and informational features, additional such features may increase the approachability of taking medicine, as well as transition the look and feel of such a pill bottle from a medical feel to a more user-friendly feel.

It would be desirable to incorporate one or more ease-of-use and informational features into a pill bottle.

It would be further desirable to provide a pill bottle with an enhanced look and feel that focuses on discretion and user-friendliness.

### SUMMARY OF THE INVENTION

It is an object of the invention to incorporate one or more ease-of-use and informational features into a pill bottle.

It is a further object of this invention to provide a pill bottle with an enhanced look and feel that focuses on discretion and user-friendliness.

A pill bottle including an external sleeve and an internal sleeve according to the invention is provided. The internal sleeve may include a cavity for holding pills. The internal sleeve may also be slidably coupled to the external sleeve. The internal sleeve can preferably move relative to the external sleeve along a longitudinal axis of the pill bottle until a predetermined limit. In an alternative embodiment of the invention, the internal sleeve may not include an independent cavity for holding pill but, rather, may include a cylinder that, together with the base of the external sleeve, may form a cavity for holding pills within the pill bottle.

In one aspect of the invention, the cavity may be filled with pills. When the internal sleeve forms the cavity by itself, the pills in the cavity may be drawn out of the external sleeve when the internal sleeve is extended—i.e., withdrawn (but not separated—therefrom. In the alternative embodiment of the invention described above, wherein the internal sleeve may only be a cylinder without a base, the pills may remain within the outer sleeve following the withdrawal of the internal sleeve from the external sleeve. It should be noted that invention may include a pill bottle and pills inside such a dispenser. Such pills according to the invention may be any pills that are specified in the FDA Orange Book for approved medications.

### BRIEF DESCRIPTION OF THE DRAWINGS

The objects and advantages of the invention will be apparent upon consideration of the following detailed description, taken in conjunction with the accompanying drawings, in which like reference characters teller to like parts throughout, and in which:

FIG. 1 is a front perspective view of a pill bottle according to the invention;

FIG. 2 is a front perspective view with a cut-away portion showing the internal electrical components according to the invention;

FIG. 3A is a perspective view of a pill bottle according to the invention showing an informational band detached from an internal sleeve;

FIG. 3B is a perspective view of a pill bottle according to the invention showing an informational band adhered to an internal sleeve;

FIG. 4 is an exploded view of a pill bottle according to the invention;

FIG. 5 is a cut-away side view of a pill bottle according to the invention; and

FIG. 6 is a pill bottle according to the invention having a cap separated therefrom.

### DETAILED DESCRIPTION OF THE INVENTION

The invention is directed to a pill bottle. Conventional pill bottles have a certain stigma of ill health attached to them. Consequently, people that take medications can be discouraged from taking medicine because of the stigma. Therefore, it is important to, where possible, reduce the stigma attached to the taking of medicine and to substantially eliminate the medical feel of certain medical paraphernalia. Such reduction of the stigma and elimination of the medical feel of certain paraphernalia may actually promote increased adherence to a medical regimen, and, consequently, promote better health.

One such pill bottle according to the invention reduces the stigma and medical feel by placing pharmacy label information onto an inner sleeve of the bottle that is slidably attached to an outer sleeve and may be discretely hidden therein. When the inner sleeve is stored within the outer sleeve, then the pharmacy label is covered and not visible. However, when the inner sleeve is extended outside the outer sleeve, the information thereon can be easily read and reviewed by an individual. Such a device may preferably promote proper adherence to a medication program by removing at least some of the stigma and embarrassment associated with carrying a bottle of pills.

A further feature of the invention includes a preferably programmable ring of light around the top of the cap (which may be augmented by an audio signal as well) that acts as a reminder when the time for taking medication has occurred.

One additional aspect of the invention preferably relates to the relationship between an internal sleeve of a pill bottle according to the invention and an external sleeve of the pill bottle. In one particular embodiment of the invention, the internal sleeve may move along a longitudinal axis with respect to the external sleeve (while preferably being restricted from detaching from the external sleeve), but may be prevented from rotating with respect to the external sleeve. In one such embodiment of the invention, this physical relationship between the internal sleeve and the external sleeve may be implemented by placing a projecting on either one of the sleeves and a corresponding groove on the other sleeve, thereby permitting relative movement between the two sleeves along a longitudinal axis and restricting relative rotation between the two sleeves.

Yet another aspect of the invention relates to the lip of the pill bottle. The pill bottle according to the invention preferably includes a lip that prevents an outflow of too many pills at a single time. Such an aspect may serve to allow a user taking medication to carefully choose a limited number of pills according to the prescribed.

This lip according to the invention may preferably be enhanced by shaping the dispensing end of the bottle in the form of a spout. As such, the bottle acts to easily pour the pills up into the spout against the lip where they are restrained and presented to a user for taking his medication. Such a design preferably helps the user take his medicine in a quick, easy, and discrete fashion.

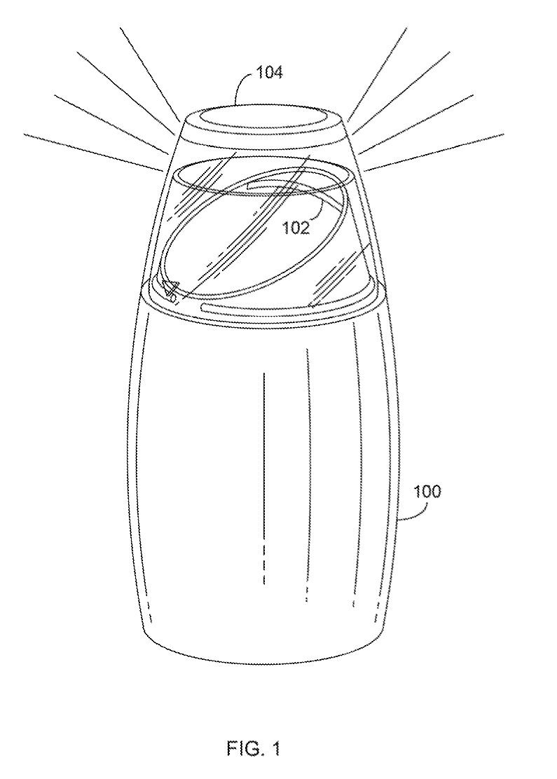

FIG. 1 shows the external sleeve 100, the lip 102 and the incorporated light information element 104 as seen from a front perspective view. In one embodiment of the invention, light information element 104 may be configured to turn ON at a certain predetermined interval to act as a reminder for taking a medication such as a pill.

Existing technologies may be incorporated to implement the light as a glowing ring around the top of pill bottle 100. Such a ring may provide an effective reminder of the need to take a medication without becoming a conspicuous alert that may be visible to others. For example, if a woman had such a bottle in her purse, when she opened the purse, the glowing ring may indicate to her that she should take a medication without lighting up the entire contents of her purse and having the light be recognizable to others around her. One (or more) Light Emitting Diode (LED) may be implemented to show such a limited, yet noticeable, reminder light in the form of a glowing ring.

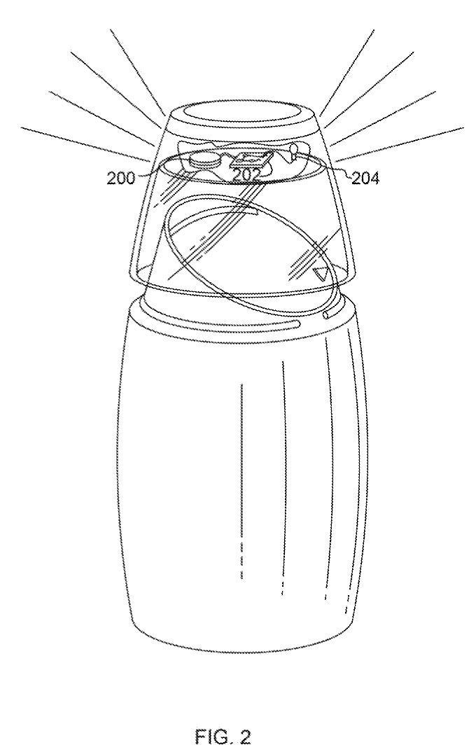

FIG. 2 shows the lighted information element in detail. Battery 200 is coupled to the central processing unit (CPU) 202 which may be coupled further to an LED 204 or other suitable light source according to the invention. CPU 202 may preferably be programmed to light up LED 204 at predetermined intervals. CPU 202 could be further programmed to terminate the illumination of the light once the lighted bottle had been opened. Alternatively, CPU 202 conk! be programmed to shut LED 204 OFF after a predetermined duration. For example, CPU 202 could be programmed to shut LED 204 OFF after a user had sufficient time to see the reminder light.

In yet another embodiment of the invention, CPU 202 could be programmed to provide a flashing light instead of a static light so as to attract the user's attention more readily. Additionally, LED may also incorporate a small clock including an audio alarm that may inform the user that the time to take medicine has arrived. In such embodiments, the user may then be informed of the reminder to take medicine even if the user could not see the actual reminder light.

In yet another embodiment of the invention, the information light could also be customizable for a specific brand target. As such, the dosage and the operation of the light could be linked in such a way as to maximize the adherence to a particular medicinal regimen.

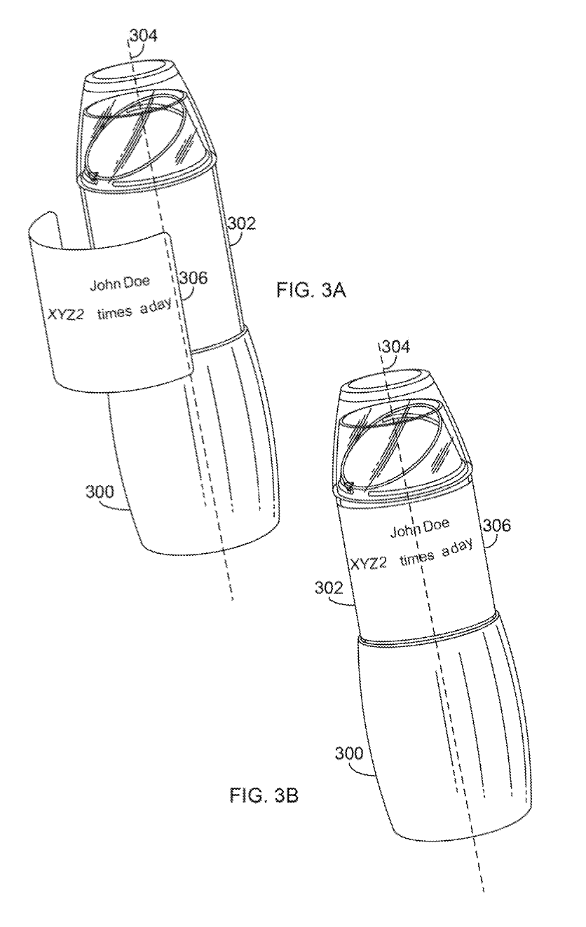

FIG. 3 shows the external sleeve 300 when the internal sleeve 302 has been extended from within external sleeve 300. FIG. 3 shows that the relative position of internal sleeve 320 with respect to external sleeve 300 has been changed (from the configuration shown in the other FIGURES) along longitudinal axis 304.

Internal sleeve 302 preferably includes a substantial space on its outer surface for displaying informational content, such as a pharmacy label, on the sleeve. FIG. 3A shows such an exemplary pharmacy label 306 as detached from sleeve 302. In such an embodiment, the pill bottle may preferably not appear as a pill bottle and, accordingly, may maintain a discrete and friendly appearance. Such an appearance may preferably encourage timely adherence to a medicinal regimen as the discrete appearance reduces at least a portion of the discomfort and unease associated with taking medicine.

FIG. 3B shows pharmacy label 306 adhered to internal sleeve 302. In FIG. 3B, it can be seen that when label 306 is adhered to internal sleeve 302, internal sleeve may be fit together with external sleeve 300 in order to form a unitary device from which the label is not visible except when internal sleeve is in an extended position.

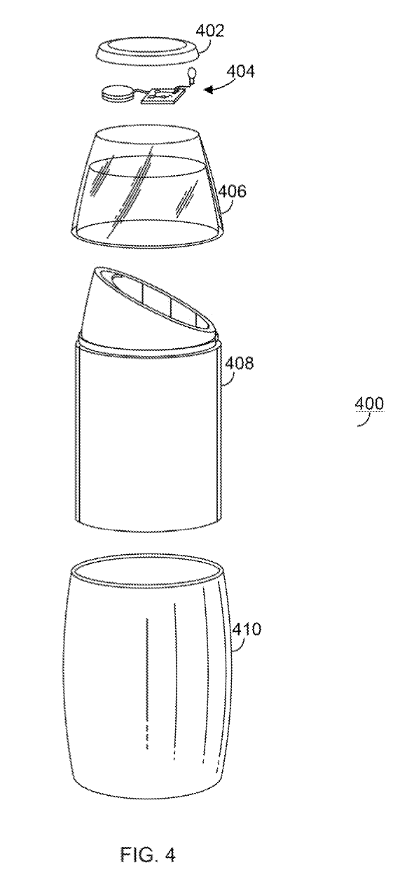

FIG. 4 shows an exploded version of a pill bottle 400 according to the invention. Pill bottle 400 includes lighted information ring 402, electronic lighting system 404, and cap 406 which may be threaded so as to screw on to either the internal sleeve or external sleeve, and cover, internal sleeve 408. Internal sleeve may be slidably attached to external sleeve 410.

The exploded view shown in FIG. 4 is one example of an embodiment of the invention which shows, essentially, five primary component parts. Nevertheless, other embodiments may contain more or less component parts without departing from the spirit or the nature of the invention. Additional embodiments of the invention could comprise, for example, just the external sleeve. In these embodiments, the external sleeve (and cap suited thereto) may be provided independently of the internal sleeve, and could be used to provide a discrete cover for existing pill bottles. In such embodiments, the interior of the external sleeve could be adapted to engage the outer surface of a generic pill bottle in such a way to substantially cover the pill bottle from the outside. Furthermore, the cap could be adapted to surround and cover the bottle from above.

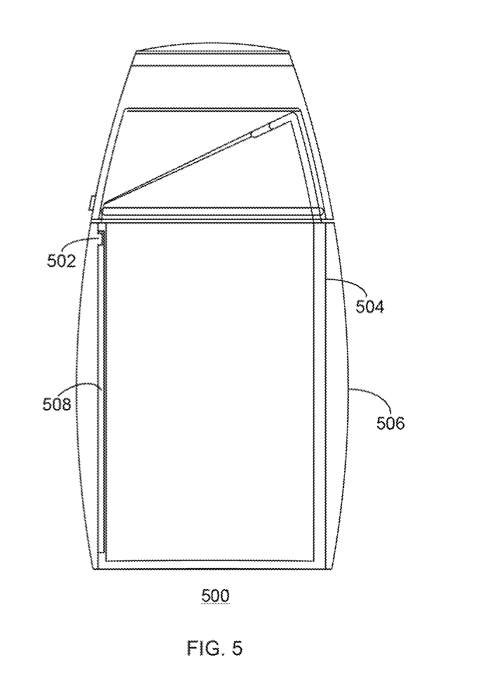

FIG. 5 shows a cut-away side view of a pill bottle 500 according to the invention. Pill bottle 500 shows a projection 502 which allows for sliding of internal sleeve 504 with respect to external sleeve 506 along a longitudinal axis of the pill bottle but, in one embodiment of the invention, prevents the rotation of internal sleeve 504 with respect to external sleeve 506. Projection 502, preferably may fit into a groove 508 in internal sleeve 504 and, thereby, allow the vertical movement of internal sleeve 504 with respect to external sleeve 506, but prevent the rotation of internal sleeve 504 with respect to external sleeve 506. In addition, because groove ends before the bottom of internal sleeve 504, projection 502 may also act to prevent internal sleeve 504 from separating completely from external sleeve 506, thereby maintaining the integrity of pill bottle 500 even when internal sleeve 504 is in an extended position.

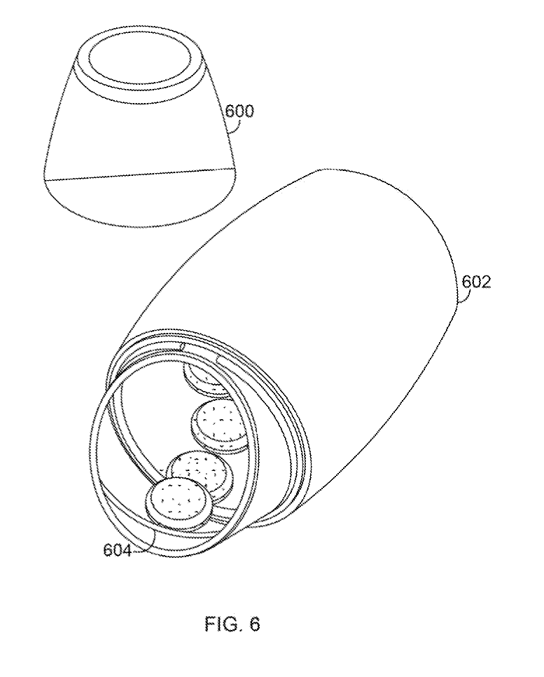

FIG. 6 shows cap 600 separated from bottle 602. FIG. 6 also shows lip 604. Lip 604 acts to prevent an unwanted amount of pills from falling out of pill bottle 602. Lip 604 preferably further acts to provide access to a certain limited number of pills from which a user can take his dosage, as shown in an exemplary fashion in FIG. 6. Thus, pill bottles according to the invention have been provided. Persons skilled in the art will appreciate that the present invention can be practiced by other than the described embodiments, which are presented for purposes of illustration rather than of limitation, and the present invention is limited only by the claims which follow.

What is claimed is:

1. A pill bottle comprising:
an external sleeve; and
an internal sleeve, said internal sleeve that comprises a cavity for holding pills, said internal sleeve slidably coupled to said external sleeve wherein said internal sleeve can move relative to said external sleeve along a longitudinal axis of said pill bottle until a predetermined limit.

2. The pill bottle of claim 1, the internal sleeve further comprising a spout for dispensing pills.

3. The pill bottle of claim 2, the spout further comprising a lip that prevents the unwanted over-dispensing of pills.

4. The pill bottle of claim 1, the internal sleeve comprising a groove and the external sleeve comprising a projection that slides within the groove, the groove that prevents substantial rotation of the of the internal sleeve with respect to the external sleeve by preventing a substantial rotational of the projection with respect to the groove.

5. The pill bottle of claim 1, the external sleeve comprising a groove and the internal sleeve comprising a projection that slides within the groove, the groove that prevents substantial rotation of the of the external sleeve with respect to the internal sleeve by preventing a substantial rotational of the projection with respect to the groove.

6. The pill bottle of claim 1, further comprising a cap, said cap further comprising a lighted information element.

7. The pill bottle of claim 6, wherein said lighted information element is customizable for a specific medication.

8. The pill bottle of claim 1, wherein the external sleeve is opaque.

9. The pill bottle of claim 1, the internal sleeve further comprising a pharmacy label.

10. A pill bottle comprising:
an external sleeve; and
an internal sleeve, said internal sleeve that comprises a cavity for holding pills, said internal sleeve slidably coupled to said external sleeve, the internal sleeve comprising a groove and the external sleeve comprising a projection that fits in the groove, the groove that prevents substantial rotation of the internal sleeve with respect to the external sleeve by preventing a substantial rotational of the projection with respect to the groove.

11. The pill bottle of claim 10, the internal sleeve further comprising a spout for dispensing pills.

12. The pill bottle of claim 11, the spout further comprising a lip that prevents the unwanted over-dispensing of pills.

13. The pill bottle of claim 10, further comprising a cap, said cap further comprising a lighted information element.

14. The pill bottle of claim 13, wherein said lighted information element is customizable for a specific medication.

15. The pill bottle of claim 10, wherein the external sleeve is opaque.

16. The pill bottle of claim 10, the internal sleeve further comprising a pharmacy label.

17. A pill bottle comprising:
an external sleeve;
an internal sleeve, said internal sleeve that comprises a cavity for holding pills, said external sleeve slidably coupled to said internal sleeve, the external sleeve comprising a groove and the internal sleeve comprising a projection that slides within the groove, the groove that prevents substantial rotation of the external sleeve with respect to the internal sleeve by preventing a substantial rotational of the projection with respect to the groove.

18. A pill bottle comprising:
an external sleeve; and
an internal sleeve, said internal sleeve that comprises a cavity for holding pills, said internal sleeve slidably coupled to said external sleeve, the internal sleeve further comprising a spout for dispensing pills, the spout further comprising a lip that prevents the unwanted over-dispensing of pills.

19. The pill bottle of claim 18, wherein said internal sleeve can move along a longitudinal axis of said pill bottle until a predetermined limit relative to said external sleeve.

20. The pill bottle of claim 18, the internal sleeve further comprising a spout for dispensing pills.

21. The pill bottle of claim 18, the internal sleeve comprising a groove and the external sleeve comprising a projection that fits in the groove, the groove that prevents substantial rotation of the of the internal sleeve with respect to the external sleeve by preventing a substantial rotational of the projection with respect to the groove.

22. The pill bottle of claim 18, the external sleeve comprising a groove and the internal sleeve comprising a projection that slides within the groove, the groove that prevents substantial rotation of the of the external sleeve with respect to the internal sleeve by preventing a substantial rotational of the projection with respect to the groove.

23. The pill bottle of claim 18, further comprising a cap, said cap further comprising a lighted information element.

24. The pill bottle of claim 23, wherein said lighted information element is customizable for a specific medication.

25. The pill bottle of claim 18, wherein the external sleeve is opaque.

26. The pill bottle of claim 18, the internal sleeve further comprising a pharmacy label.

27. A pill bottle comprising:
an external sleeve;
an internal sleeve, said internal sleeve that comprises a cavity for holding pills, said internal sleeve slidably coupled to said external sleeve wherein said internal sleeve can move relative to said external sleeve along a longitudinal axis of said pill bottle until a predetermined limit; and
a plurality of pills that are located in said cavity.

28. The pill bottle of claim 27, the internal sleeve further comprising a spout for dispensing pills.

29. The pill bottle of claim 28, the spout further comprising a lip that prevents the unwanted over-dispensing of pills.

30. The pill bottle of claim 27, the internal sleeve comprising a groove and the external sleeve comprising a projection that slides within the groove, the groove that prevents substantial rotation of the of the internal sleeve with respect to the external sleeve by preventing a substantial rotational of the projection with respect to the groove.

31. The pill bottle of claim 27, the external sleeve comprising a groove and the internal sleeve comprising a projection that slides within the groove, the groove that prevents substantial rotation of the of the external sleeve with respect to the internal sleeve by preventing a substantial rotational of the projection with respect to the groove.

32. The pill bottle of claim 27, the internal sleeve further comprising a pharmacy label.
